(19) United States
(12) Patent Application Publication
(10) Pub. No.: US 2002/0133342 A1
(43) Pub. Date: Sep. 19, 2002

(54) Speech to text method and system

(76) Inventor: Jennifer McKenna, Philadelphia, PA (US)

Correspondence Address: Stephen J. Weed, Esquire, Synnestvedt & Lechner LLP, Suite 2600, 1101 Market Street, Philadelphia, PA, 19107-2950, US

(21) Appl. No.: 10/100,744

(22) Filed: Mar. 18, 2002

Related U.S. Application Data
(60) Provisional application No. 60/276,572, filed on Mar. 16, 2001.

(51) Int. Cl. G10L 15/26

(52) U.S. Cl. 704/235

(57) ABSTRACT

The present invention is an automated dictation method and system for converting speech to text. The invention includes a voice manipulation system for converting a speech signal that is based on spoken words to a standardized signal and a dictation system for generating a textual representation of the spoken words using the standardized signal.

### RELATED APPLICATIONS

This application claims the benefit of U.S. Provisional Application to McKenna, entitled “SPEECH TO TEXT METHOD AND APPARATUS,” filed Mar. 16, 2001, Application No. 60/276,572.

### FIELD OF THE INVENTION

The present invention relates to dictation systems and, more particularly, to an automated method and system for converting speech to text.

### BACKGROUND OF THE INVENTION

Dictation systems are used to obtain a written record of spoken words. In a simple dictation system, a speaker's spoken words are manually transcribed by a listener. This manual process is cumbersome, prone to errors, and prevents the listener from providing full attention to the speaker. Accordingly, automated methods and systems for creating a written record of spoken words are highly desirable.

Current automated dictation systems use a computer program running on a computer to transcribe spoken words. In this type of system, a person speaks into a microphone attached to the computer and the computer program attempts to transcribe the speaker's words into written text using acoustic models. Typically, these systems require that the speaker “train” the computer program by reading words and phrases out loud for interpretation by the computer program. During training, the computer program adapts the acoustic models to the speaker's voice and stores them for later use.

The existing computer based automated dictation systems require time and energy to “train” the computer program to recognize each user's voice. This is especially burdensome if the voices of multiple speakers are to be transcribed using a single automated dictation system. For example, if a student wants to transcribe multiple lectures with different speakers, the automated dictation system would have to be trained by each speaker. Having each speaker train the system would not be realistic. Accordingly, an unsatisfied need exists for an automated dictation system which can transcribe spoken words without requiring that each speaker “train” the system. The present invention satisfies this need.

### SUMMARY OF THE INVENTION

The present invention provides an automated dictation system for converting spoken words to text. The aforementioned problem is overcome by standardizing a speech signal that is based on the spoken words and, then, generating a textual representation of the spoken words based on the standardized signal. Since the speech signal is standardized, the system can be used to convert words spoken by multiple speakers without having each individual speaker train the system.

One aspect of the present invention is a speech to text conversion system that includes a voice manipulation system for standardizing a speech signal that corresponds to spoken words, and a dictation system for generating a textual representation of the spoken words using the standardized signal.

Another aspect of the invention is a method for converting speech to text that includes standardizing a speech signal that corresponds to spoken words, and generating a textual representation of the spoken words using the standardized signal.

In addition, the present invention encompasses systems and computer program products for carrying out the inventive method.

### BRIEF DESCRIPTION OF THE DRAWINGS

FIG. 1 is a flow chart of a general overview of a speech to text conversion method in accordance with the present invention;

FIG. 2 is a block diagram of a functional representation of a speech to text conversion system in accordance with the present invention;

FIG. 3A is a flow chart of an illustrative speech to text conversion method in accordance with the present invention; and

FIG. 3B is a flow chart of an alternative illustrative speech to text conversion method in accordance with the present invention.

### DETAILED DESCRIPTION OF THE INVENTION

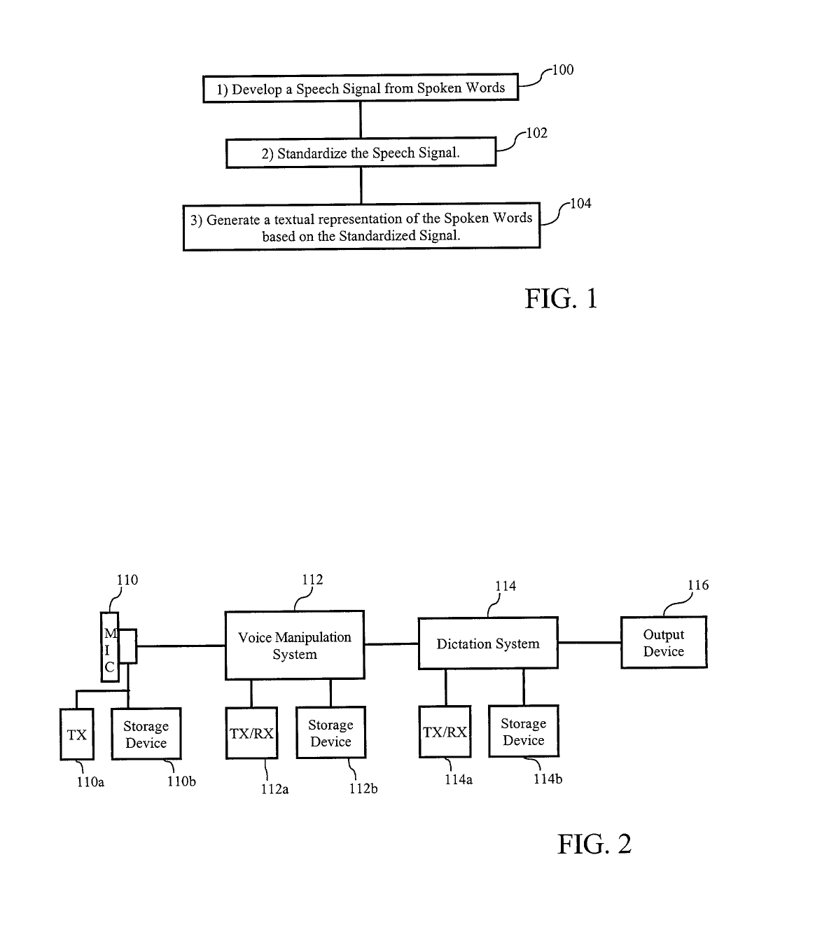

FIG. 1 depicts the general steps required for converting speech to text in accordance with the present invention. At step 1, illustrated by block 100, a speech signal is developed from words spoken by a speaker, i.e., spoken words. At step 2, illustrated by block 102, the speech signal of step 1 is standardized such that the speech signal for identical spoken words is the same regardless of speaker. At step 3, illustrated by block 104, a textual representation of the spoken words of step 1 is generated using the standardized signal of step 2.

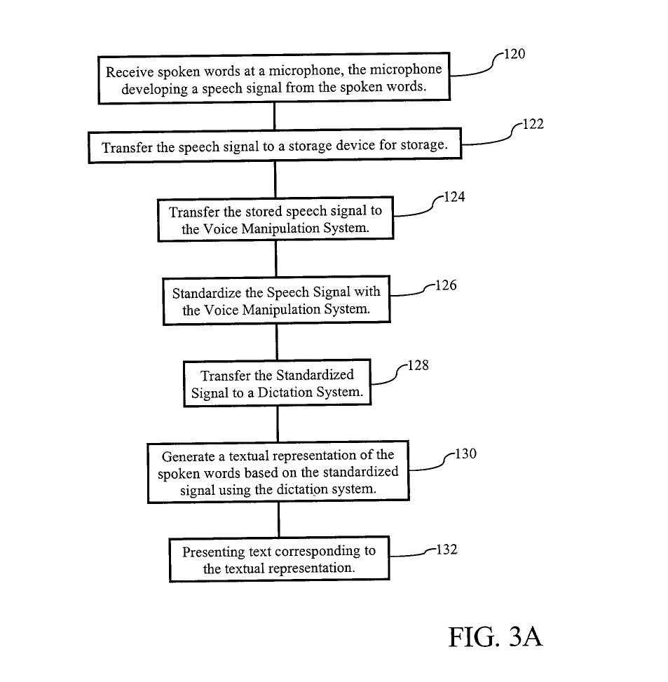

FIG. 2 is a block diagram illustrating an embodiment of a dictation system in accordance with the present invention. The block diagram is a logical representation of functional components for use in the present invention and is not meant to imply an actual separation of components in hardware. The functional components include a microphone 110, a voice manipulation system 112, a dictation system 114, and an output device 116. In a general overview, the microphone 110 develops a speech signal from spoken words. The speech signal is then transferred to the voice manipulation system 112, where the speech signal is converted to a standardized signal that, for identical spoken words, is essentially the same regardless of speaker. The standardized signal is then transferred to the dictation system 114, where a textual representation of the spoken words is generated using the standardized signal. Since the speech signal is standardized, the dictation system 114 needs to recognize only one speaker (e.g., a “standardized” speaker) to transcribe words spoken by multiple speakers. The system of FIG. 2 will now be described in greater detail.

The microphone 110 is a device that converts a speaker's spoken words to a speech signal. The speech signal may be an electronic analog or digital signal that corresponds to the spoken words. A suitable microphone 110 for use with the present invention will be readily apparent to those skilled in the art. As illustrated, the microphone 1 10 may be operatively associated with a transmitter 110a for transmitting the speech signal in a wireless environment and/or may be operatively associated with a storage device 110b for storing the speech signal. Suitable transmitters 10a will be readily apparent to those skilled in the art. The storage device 110b may be a conventional memory device such as a hard drive, a floppy drive, a CD ROM drive, a memory stick read/write device, or essentially any device capable of storing data. An example of a microphone 102 having an operatively associated storage device for use in the present invention is a Sony digital recorder, Model ICD-MS 1, produced by Sony Corp. of Tokyo, Japan, which uses a Memory Stick for storage. The selection of a suitable storage device for use with the present invention will be readily apparent to those skilled in the art.

The voice manipulation system 112 converts a speech signal to a standardized signal. The voice manipulation system 112 alters the speech signal such that the standardized signal output by the voice manipulation system 112 is very similar, if not the same, for each speaker who utters the same spoken words. For example, the word “CAR” spoken by a person with a low gruff voice would produce essentially the same standardized signal (or portion of the signal) as the word “CAR” spoken by a person with a high-pitched smooth voice. The speech signal is standardized by manipulating aspects of the speech signal corresponding to the spoken word's frequency and pitch. An example of a voice manipulation system 112 which may be used with the present invention is the voice manipulation system within a TalkBoy™ produced by Sony Corp. The TalkBoy™ is a device capable of recording a speaker's voice and playing it back with a different frequency and pitch. Other suitable voice manipulation systems will be readily apparent to those skilled in the art.

In one embodiment, the voice manipulation system 112 may be implemented as voice manipulation computer program code running on a computer. The voice manipulation computer program code may be stored on a computer readable medium to form a computer program product. When run on a processing device such as a computer, the voice manipulation computer program code performs the functions of the voice manipulation system 112 as described above. The creation of suitable computer program code for use with the present invention will be readily apparent to those skilled in the art.

As illustrated, the voice manipulation system 112 may be operatively associated with a transmitter/receiver 112a for receiving a speech signal and/or transmitting a standardized signal in a wireless environment. In addition, the voice manipulation system 112 may be operatively associated with a storage device 112b for retrieving a speech signal and/or storing the standardized signal. Suitable transmitter/receivers 112a will be readily apparent to those skilled in the art. The storage device 112b may be a conventional memory device such as described above with reference to the storage device 110b associated with the microphone 110.

A speech signal may be transferred to the voice manipulation system 112 directly from the microphone 110. In an alternative embodiment, a speech signal may be transferred by transmitting the speech signal using the transmitter 110a associated with the microphone 110 for reception at the transmitter/receiver 112a associated with the voice manipulation system 112. In another embodiment, the speech signal is transferred using a portable computer readable medium such as a Memory Stick or floppy disk associated with the storage devices 110b, 112b. In yet another embodiment, the storage devices 110b, 112b are a common storage device accessible locally or over a network, allowing speech signals stored by the microphone 110 to be transferred by storing the speech signal to the common storage device with the microphone 110 and retrieving the speech signal with the voice manipulation system 112. Various other embodiment for transferring the speech signal from the microphone 110 to the voice manipulation system 112 will be apparent to those skilled in the art.

The dictation system 114 is a conventional dictation system for transcribing the signal standardized by the voice manipulation system 112 to generate a textual representation of the spoken words. Since the voice manipulation system 112 standardizes the speech signal such that it is essentially identical for the same spoken words regardless of speaker, the dictation system 114 is capable of generating a textual representation of the words spoken by essentially any speaker as long as a “standardized” reference voice is recognized by the dictation system 114. In certain preferred embodiments, the dictation system 114 is configured to recognize the standardized reference voice at a production facility. In certain other preferred embodiments, a single speaker teaches the system of the present invention by having the voice manipulation system 112 standardize a predefined series of speech signals created from words spoken by the single speaker. The standardized signals are then used to train the dictation system 114 to recognize the standardized signals. An example of a suitable dictation system 114 is a conventional dictation computer program running on a computer. An example of a suitable dictation computer program is Dragon NaturallySpeaking™, Version 5.0, available from ScanSoft®, Inc. of Peabody, Mass., USA.

The dictation computer program may be stored on a computer readable medium. As illustrated, the dictation system 114 may be operatively associated with a transmitter/receiver 114a for receiving standardized signals and/or transmitting textual representations in a wireless environment. In addition, the voice manipulation system 112 may be operatively associated with a storage device 112b for retrieving the standardized signal and/or storing the textual representation. Suitable transmitter/receivers 112a will be readily apparent to those skilled in the art. The storage device 11 2b may be a conventional memory device such as described above with reference to storage device 110b.

The standardized signal may be transferred to the dictation system 114 directly from the voice manipulation system 112. In an alternative embodiment, a standardized signal may be transferred by transmitting the standardized signal using the transmitter/receiver 112a associated with the voice manipulation system 112 for reception at the transmitter/receiver 114a associated with the dictation system 114. In another embodiment, the standardized signal is transferred using a portable computer readable medium such as a Memory Stick or floppy disk associated with the storage devices 112b, 114b. In yet another embodiment, the storage devices 112b, 114b are a common storage device accessible locally or over a network, allowing standardized signals stored by the voice manipulation system 112 to be transferred by storing the standardized signal to the common storage device with the voice manipulation system 112 and retrieving the standardized signal with the dictation system 114. Various other embodiment for transferring the standardized signal from the voice manipulation system 112 to the dictation system 114 will be apparent to those skilled in the art.

The output device 116 is a device for presenting the textual representation of the spoken words to a user. The output device 116 may include a conventional printer for outputting text in printed format and/or a conventional monitor on which text may be displayed. In the preferred embodiment, the printer and/or monitor are configured in a known manner to present the textual representation generated by the dictation system 114. In certain preferred embodiments, the printer outputs visible text which can be read visually by a reader. In certain other embodiments, the printer is a braille printer that outputs brail text that can be read by a visually impaired reader through touch. The printer and/or monitor are operatively associated with the dictation system 114 in a known manner to receive the textual representation from the dictation system 114.

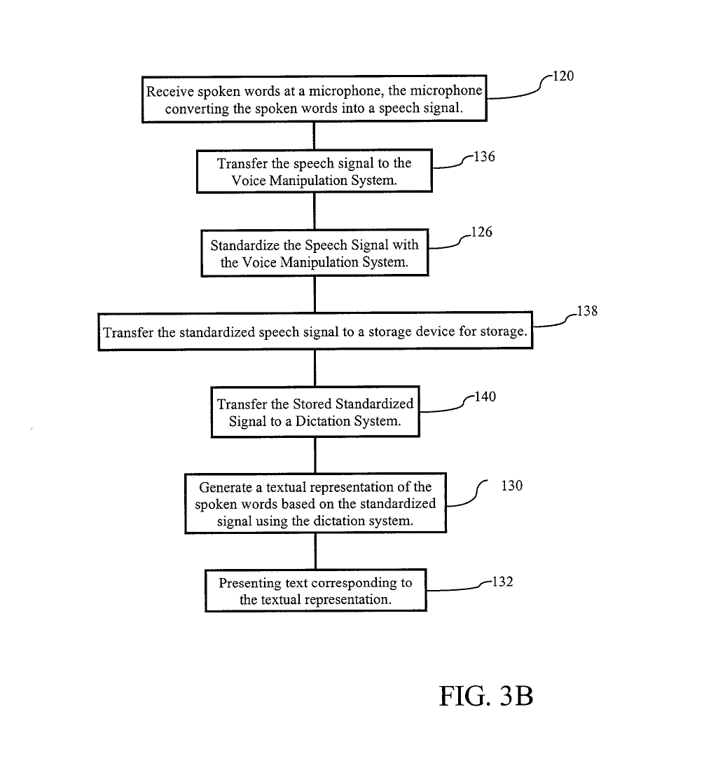

FIG. 3A is an illustrative flow diagram of one embodiment for converting speech to text in accordance with the present invention. At block 120, spoken words are received at a microphone 110 (FIG. 2) for conversion into a speech signal that is an analog or digital representation of the spoken words. At block 122, the speech signal is transferred to a storage device 10b associated with the microphone 110. In the illustrative embodiment of FIG. 3A, the storage device 110b stores the speech signal for standardization and transcription at a later time. If the speech signal is standardized and transcribed immediately, the storing step (i.e., block 122) can be eliminated. The steps of blocks 120, 122 may be performed by a Sony ICD-MS1 digital recorder (produced by Sony Corp. of Tokyo, Japan), which stores data on a Memory Stick.

At block 124, the speech signal stored in the step of block 122 is transferred to a voice manipulation system 112 (FIG. 2). If the speech signal is stored on a Memory Stick at block 122, the speech signal may be transferred to the voice manipulation system 112 by transferring the Memory Stick to a storage device 112b associated with the voice manipulation system 112, such as a conventional Memory Stick read/write device.

At block 126, the voice manipulation system 112 (FIG. 2) standardizes the speech signal. At block 128, the standardized signal is transferred to the dictation system 114 (FIG. 2). If the dictation system 114 is coupled to the voice manipulating system 112, the standardized signal is transferred directly from the voice manipulation system to the dictation system 114.

At block 130, the dictation system 114 (FIG. 2) generates a textual representation of the spoken words based on the standardized signal. At block 132, the textual representation is presented at an output device 116 in a known manner.

FIG. 3B is an illustrative flow diagram of an alternative embodiment for converting speech to text in accordance with the present invention. The flow diagram of FIG. 3B is identical to the flow diagram of FIG. 3A with the exception that, in the embodiment depicted in FIG. 3B, the standardized signal is stored, rather than the speech signal as in block 122 of the embodiment illustrated in FIG. 3A. Only steps that are different will be described in detail with like steps being identically numbered.

At block 136, the speech signal of block 120 is transferred to the voice manipulation system 112 (FIG. 2). If the voice manipulation system 112 is coupled to the microphone 110, the speech signal is transferred directly from the microphone 110 to the voice manipulation system 112.

At block 138, the signal standardized in block 126 is transferred to a storage device 112b (FIG. 2). At block 140, the standardized signal is transferred from the storage device 112b to the dictation system 114.

Using readily available components, the present invention can be practiced in the following manner. The components include a Sony TalkBoy™, a Sony ICD-MS1 storage device (which stores data on a Memory Stick), a computer, a Memory Stick reader/writer (which is connected to the computer via a USB port), and Dragon Dictation version 5.0 computer program running on the computer. A textual representation of spoken words is generated by, first, recording spoken words with the TalkBoy. The TalkBoy stores the spoken words as a speech signal on a conventional cassette tape. The TalkBoy is then used to standardize the spoken words. Standardization is accomplished by playing back the recorded speech signal in “SLOW” mode. The TalkBoy converts the standardized signal to an audio signal during playback. The audio signal is the converted back to the standardized signal by a Sony ICD-MS1 storage device, which stores the standardized signal on a Memory Stick. After the standardized signal is stored on the Memory Stick, the Memory Stick is transferred from the Sony ICD-MS1 storage device to the Memory Stick reader/writer connected to the computer. The Dragon Dictation version 5.0 software on the computer is configured in a known manner to receive signals from the Memory Stick reader/writer and to generate a textual representation of the spoken words using the standardized signal. Although, in this example, the standardized signal is converted to an audio signal and then converted back to a standardized signal, it will be apparent to those skilled in the art that the circuitry within the Sony TalkBoy can be used to convert the speech signal to a standardized signal that can be stored directly onto a storage medium such as a Memory Stick without any intermediate processing steps.

In the embodiments of the present invention described above, the method and system convert all speech signals for a given spoken word (or set words) to a single standardized signal and, then, generate a textual representative of the spoken words using the standardized signal. However, in an alternative embodiment, to increase voice recognition accuracy, the voice manipulation system 104 (or a voice manipulation program which performs the function of the voice manipulation system 104) may be configured to convert some speech signals to one standardized signal having certain characteristics and other speech signals to another standardized signal having other characteristic. For example, to accommodate large differences between the characteristics of male and female voices, the voice manipulation system 104 may be configured to standardize speech signals for one group of individuals (e.g., male speakers) to one standardized signal having certain characteristic and another voice type (e.g., female voices) to another standardized signal having other characteristic. In this embodiment, the voice dictation system 108 would be configured to recognize two different standardized signals (e.g., a male standardized signal and a female standardized signal). The selection of a standardized model having desirable characteristics may be performed manually by a user via a switch or automatically. Variations such as this are within the scope of the present invention and will be readily apparent to those skilled in the art.

The present invention may be used for a wide range of applications. The following applications are an illustrative, but by no means exhaustive, list of potential uses for the present invention. The present invention may be used to transcribe lectures, meetings, and phone conversation. In addition, the present invention may be used to transcribe voice mail and answering machine messages. For example, the voice mail message may be stored as a speech signal on a storage device. The speech signal can then be standardized by a voice manipulation system to create a standardized signal for use by a dictation system to generate a textual representation of the voice mail message.

Having thus described a few particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A speech to text conversion system comprising:
a voice manipulation system for standardizing a speech signal, said speech signal corresponding to spoken words; and
a dictation system for generating a textual representation of said spoken words based on said standardized signal.

2. The system of claim 1, further comprising:
a microphone for developing said speech signal from said spoken words.

3. The system of claim 2, wherein said microphone comprises at least a transmitter and said voice manipulation system comprises at least a receiver, said microphone transmitting said speech signal using said transmitter for receipt at said voice manipulation system through said receiver.

4. The system of claim 1, further comprising:
a storage device.

5. The system of claim 4, wherein said storage device is configured to store said speech signal.

6. The system of claim 4, wherein said storage device is configured to store said standardized signal.

7. The system of claim 1, further comprising:
an output device for presenting said textual representation.

8. The system of claim 7, wherein said output device is a monitor operatively associated with said dictation system for displaying text corresponding to said textual representation.

9. The system of claim 7, wherein said output device is a printer operatively associated with said dictation system for printing text corresponding to said textual representation.

10. The system of claim 9, wherein said printer is a braille printer.

11. A method for converting speech to text comprising the steps of:
standardizing a speech signal, said speech signal corresponding to spoken words; and
generating a textual representation of said spoken words based on said standardized signal.

12. The method of claim 11, further comprising:
storing said standardized signal for use in said generating step.

13. The method of claim 11, further comprising:
storing said speech signal for use during said standardizing step.

14. The method of claim 11, wherein said standardizing step comprises at least the step of:
manipulating said speech signal such that after standardization the signal will be essentially equivalent for said spoken words regardless of speaker.

15. The method of claim 11, further comprising:
presenting text corresponding to said textual representation.

16. The method of claim 15, wherein said presenting step comprises at least displaying said text on a monitor.

17. The method of claim 15, wherein said presenting step comprises at least printing said text.

18. A computer program product for speech to text conversion, said computer program product comprising:
computer readable program code embodied in a computer readable medium, the computer readable program code comprising at least:
computer readable program code for standardizing a speech signal, said speech signal corresponding to spoken words; and
computer readable program code for generating a textual representation of said spoken words based on said standardized signal.

19. A system for speech to text conversion, said system comprising:
means for standardizing a speech signal, said speech signal corresponding to spoken words; and
means for generating a textual representation of said spoken words based on said standardized signal.
